(19) United States
(12) Patent Application Publication
(10) Pub. No.: US 2025/0148778 A1
(43) Pub. Date: May 8, 2025

(54) METHOD AND APPARATUS FOR DETERMINING FAIL-SAFE OF CAMERA IMAGE RECOGNITION

(71) Applicants: Hyundai Motor Company, Seoul (KR); Kia Corporation, Seoul (KR)

(72) Inventors: Da Ye Oh, Suwon-si (KR); Seung Yeon Jo, Seoul (KR)

(21) Appl. No.: 18/609,662

(22) Filed: Mar. 19, 2024

(30) Foreign Application Priority Data
Nov. 6, 2023 (KR) 10-2023-0151991

(51) Int. Cl. G06V 10/98; G06V 10/26

(52) U.S. Cl. CPC G06V 10/98; G06V 10/26

(57) ABSTRACT

Disclosed are embodiments for a method and apparatus for detecting soiling of camera image recognition. In an embodiment, the method includes obtaining an altitude and an azimuth of the sun based on a current date, a current time, and location information of a vehicle, generating a straight line between the sun and a camera in a three-dimensional space based on the altitude and the azimuth of the sun, generating a lens surface of the camera in the three-dimensional space based on a moving direction of the vehicle and a lens surface angle of the camera, and determining that an error occurs in image recognition of the camera when the straight line passes through the lens surface.

### CROSS-REFERENCE TO RELATED APPLICATIONS

This application claims the benefit of Korean Patent Application No. 10-2023-0151991, filed on Nov. 6, 2023, which application is hereby incorporated herein by reference.

### TECHNICAL FIELD

The present disclosure relates to a technology for determining camera image recognition fail-safe.

### BACKGROUND

Fail-safe can mean that when a malfunction occurs in a device, the entire system operates in a safe mode due to the malfunction. When fail-safe is applied to a vehicle, the vehicle operates in a safety mode to protect the driver and passengers in the event of a system malfunction. Specifically, for autonomous vehicles, this fail-safe function is important.

The most important components in autonomous vehicles are various sensors that perform cognitive functions. For example, an autonomous vehicle identifies the driving environment through cameras, lidar sensors, and radar sensors and controls autonomous driving. Therefore, it is necessary to identify failures occurring in such sensors and perform a fail-safe function in response thereto.

A fail-safe function (Vision Fail-Safe (VFS)) for camera image recognition according to the related art uses a pixel segmentation based artificial intelligence learning model, for example, a deep learning model to determine whether an error occurs in image recognition from camera image information.

However, a technology according to the related art does not recognize the VFS situation or delays determination when a sudden change in illumination occurs when entering a tunnel or changing direction of the vehicle.

### SUMMARY

The present disclosure relates to a technology for determining camera image recognition fail-safe, and more particularly, to a method of determining camera image recognition fail-safe, which is capable of determining whether camera image recognition is fail-safe based on the position of the sun, and a device thereof.

An embodiment of the present disclosure can solve the above-mentioned problems occurring in the prior art while advantages achieved by the prior art are maintained intact.

An embodiment of the present disclosure provides a method of determining fail-safe (or detecting soiling) of camera image recognition, which is capable of determining whether camera image recognition is fail-safe based on the position of the sun, and an apparatus thereof.

An embodiment of the present disclosure provides a method of determining fail-safe of camera image recognition, which is capable of improving image non-recognition or misrecognition of a camera due to the sun by determining the direction of the sun through the current location of a vehicle, time, and orientation information, and the like and using the determination result as a reference value for determining image recognition fail-safe for each camera, and an apparatus thereof.

An embodiment of the present disclosure provides a method of determining fail-safe of camera image recognition, which is capable of improving the delayed determination of image recognition fail-safe that may occur due to sudden changes in illumination when entering a tunnel or changing vehicle direction.

Technical problems that can be solved by an embodiment of the present disclosure are not necessarily limited to the aforementioned problems, and other technical problems can be clearly understood from the following description by those skilled in the art to which the present disclosure pertains.

According to an embodiment of the present disclosure, a method of detecting soiling (or determining fail-safe) of camera image recognition includes obtaining an altitude and an azimuth of the sun based on a current date, a current time, and location information of a vehicle, generating a straight line between the sun and a camera in three-dimensional space based on the altitude and the azimuth of the sun, generating a lens surface of the camera in three-dimensional space based on a moving direction of the vehicle and a lens surface angle of the camera, and determining that an error occurs in image recognition of the camera when (or if) the straight line passes through the lens surface.

According to an embodiment, the obtaining of the altitude and the azimuth may comprise obtaining the altitude and the azimuth of the sun corresponding to the current date, the current time, and the location information of the vehicle by using a sun path diagram.

According to an embodiment, the generating of the lens surface of the camera may comprise obtaining three points on X, Y, and Z axes in three-dimensional space based on the moving direction of the vehicle and the lens surface angle, and generating a surface created by the three points as the lens surface of the camera.

According to an embodiment, the determining of the error occurrence may comprise determining that the error occurs in the image recognition of the camera based on a position of the sun during a first time preset.

According to an embodiment, the determining of the error occurrence may comprise determining whether the error occurs in the image recognition of the camera by using an artificial intelligence learning model based on pixel segmentation using image information captured by the camera during a second time set to be longer than the first time as input if it is not determined that the error occurred in the image recognition of the camera based on the position of the sun during the first time.

According to an embodiment, the method may further comprise outputting a result of determining that the error occurs in the image recognition of the camera at a time point when the second time elapses if it is determined that the error occurs in the image recognition of the camera based on the position of the sun or the artificial intelligence learning model.

According to an embodiment, the determining of the error occurrence may comprise determining that the error occurs in the image recognition of the camera if it is determined that the error occurs in the image recognition of the camera based on the position of the sun during the first time, and if it is determined that the error occurs in the image recognition of the camera by using an artificial intelligence learning model based on pixel segmentation using image information captured by the camera during a second time set to be longer than the first time as input.

According to an embodiment of the present disclosure, a method of detecting soiling of camera image recognition includes obtaining location information of the sun based on a current date and a current time, generating a straight line between the sun and a camera based on position information of the sun and location information of a vehicle, and determining whether an error occurs in image recognition of the camera based on the straight line, a capturing direction of the camera, and a moving direction of the vehicle.

According to an embodiment of the present disclosure, an apparatus for detecting soiling of camera image recognition includes a processor and a memory. The processor may obtain an altitude and an azimuth of the sun based on a current date, current time, and location information of a vehicle, generate a straight line between the sun and a camera in a three-dimensional space based on the altitude and the azimuth of the sun, and generate a lens surface of the camera in the three-dimensional space based on a moving direction of the vehicle and a lens surface angle of the camera, and determine that an error occurs in image recognition of the camera when (or if) the straight line passes through the lens surface.

According to an embodiment, the processor may obtain the altitude and the azimuth of the sun corresponding to the current date, the current time, and the location information of the vehicle by using a sun path diagram.

According to an embodiment, the processor may obtain three points on X, Y, and Z axes in the three-dimensional space based on the moving direction of the vehicle and the lens surface angle, and generate a surface created by the three points as the lens surface of the camera.

According to an embodiment, the processor may determine that the error occurs in the image recognition of the camera based on the position of the sun during a first time preset.

According to an embodiment, the processor may determine whether the error occurs in the image recognition of the camera by using an artificial intelligence learning model based on pixel segmentation using image information captured by the camera during a second time set to be longer than the first time as input if it is not determined that the error occurred in the image recognition of the camera based on the position of the sun during the first time.

According to an embodiment, the processor may output a result of determining that the error occurs in the image recognition of the camera at a time point when the second time elapses if it is determined that the error occurs in the image recognition of the camera based on the position of the sun or the artificial intelligence learning model.

According to an embodiment, the processor may determine that the error occurs in the image recognition of the camera if it is determined that the error occurred in the image recognition of the camera based on the position of the sun during the first time, and if it is determined that the error occurs in the image recognition of the camera by using an artificial intelligence learning model based on pixel segmentation using image information captured by the camera during a second time set to be longer than the first time as input.

The features briefly summarized above with respect to embodiments of the present disclosure are merely examples of the detailed description of the present disclosure described below and do not necessarily limit the scope of the present disclosure.

### BRIEF DESCRIPTION OF THE DRAWINGS

The above and other features and advantages of the present disclosure can be more apparent from the following detailed description taken in conjunction with the accompanying drawings, in which:

FIG. 1 is a flowchart illustrating a method of determining fail-safe of camera image recognition according to an embodiment of the present disclosure;

FIG. 2 is a diagram illustrating an example of a scheme of obtaining an altitude and an azimuth angle of the sun according to an embodiment of the present disclosure;

FIG. 3 is a diagram illustrating an example of an operation of generating a straight line equation between the sun and a camera according to an embodiment of the present disclosure;

FIG. 4 is a diagram illustrating an example of an operation of generating the lens surface of a camera according to an embodiment of the present disclosure;

FIG. 5 is a diagram illustrating an example of a scheme of determining the VFS of a camera according to an embodiment of the present disclosure;

FIG. 6 is a diagram illustrating VFS determination based on sun position and VFS determination based on deep learning, according to an embodiment of the present disclosure;

FIG. 7 is a flowchart illustrating an example of a VFS determination operation when entering a tunnel during the day or changing a vehicle direction, according to an embodiment of the present disclosure;

FIG. 8 is a flowchart illustrating an example of a VFS determination operation when driving on a general road during the day, according to an embodiment of the present disclosure;

FIG. 9 is a block diagram illustrating an apparatus for determining fail-safe of camera image recognition according to an embodiment of the present disclosure; and

FIG. 10 is a block diagram illustrating a computing system for executing a method of determining fail-safe of camera image recognition according to an embodiment of the present disclosure.

### DETAILED DESCRIPTION OF ILLUSTRATIVE EMBODIMENTS

Hereinafter, various embodiments of the present disclosure will be described in detail with reference to the accompanying drawings, so that those skilled in the art can easily carry out an embodiment of the present disclosure. However, possible embodiments of the present disclosure are not limited to the embodiments set forth herein and may be modified variously in many different forms.

In describing the embodiments of the present specification, when a specific description of the related art is deemed to obscure the subject matter of the embodiments of the present specification, the detailed description can be omitted. In the drawings, the portions irrelevant to the description may not be shown to make the present disclosure clear.

It can be understood that when an element is referred to as being “connected” or “coupled” to another element, it may be directly connected or indirectly connected to another element. In addition, when some part ‘includes’ or “has” some elements, unless explicitly described to the contrary, other elements may be further included but not excluded.

Expressions such as “first,” or “second,” and the like, may express their elements regardless of their priority or importance and may be used to distinguish one element from another element but is not necessarily limited to these components. Therefore, without departing from the scope of the present disclosure, a first component of one embodiment may be referred to as a second component of another embodiment. Similarly, a second component of one embodiment may be referred to as a first component of another embodiment.

In the present disclosure, components can be distinguished from each other for clearly describing characteristics, and the components are not necessarily separated. A plurality of components may be integrated to form a single hardware or software unit, or a single component may be distributed to form a plurality of hardware or software units. Accordingly, such integrated or distributed embodiments are included in the scope of the present disclosure.

In the present disclosure, components described in various embodiments are not necessarily essential components, and some may be optional components. Therefore, an embodiment composed of a subset of components described in an embodiment can be also included in the scope of the present disclosure. In addition, embodiments including other components in addition to the components described in various embodiments can be also included in the scope of the present disclosure.

In the present disclosure, expressions of positional relationships used herein, such as upper, lower, left, right, and the like, can be described for convenience of description. When viewing the drawings shown in this specification in reverse, the positional relationship described in the specification may be interpreted in the opposite manner.

As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases.

An embodiment of the present disclosure can determine the image recognition fail-safe of a camera based on the position of the sun in a daytime situation with the sun to improve the delayed determination of image recognition fail-safe that may occur due to a sudden change in illumination when entering a tunnel or a change in a vehicle direction, and improve image non-recognition or misrecognition of a camera caused by the sun, for example.

According to an embodiment of the present disclosure, it is possible to generate a straight line equation between the sun and a camera based on the position of the sun, and determine that an error occurs in the image recognition of a camera due to the sun when the straight line equation passes through a lens surface after generating the lens surface of the camera by using a moving direction of the vehicle and a lens surface angle.

According to an embodiment of the present disclosure, it is possible to determine whether an error occurs in the image recognition of a camera using VFS determination based on the position of the sun and/or VFS determination by using an artificial intelligence learning model based on pixel segmentation, for example.

According to an embodiment of the present disclosure, in the case of entering a tunnel during the day or changing a vehicle direction, it is possible to determine whether an error occurs in the image recognition of a camera by using at least one of VFS determination based on the position of the sun or VFS determination using an artificial intelligence learning model, for example.

According to an embodiment of the present disclosure, in the case of driving on a general road during the day, when it is determined that an error occurs in the image recognition of a camera based on both VFS determination using the position of the sun and VFS determination using an artificial intelligence learning model, it is possible to determine that an error occurs in the image recognition of the camera.

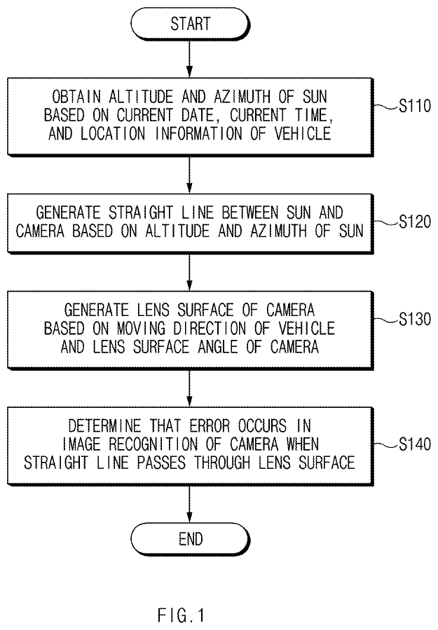

A method and apparatus according to some embodiments of the present disclosure will be described with reference to FIGS. 1 to 9.

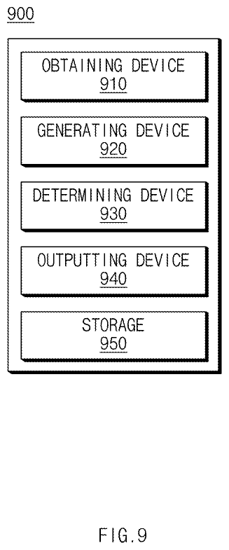

FIG. 1 is a flowchart illustrating a method of determining fail-safe of camera image recognition according to an embodiment of the present disclosure, where the flowchart illustrates operations of an apparatus for determining fail-safe of camera image recognition shown in FIG. 9.

Referring to FIG. 1, a method of determining fail-safe of camera image recognition according to an embodiment of the present disclosure obtains the altitude and the azimuth of the sun based on the current date, current time, and location information of the vehicle in operation S110.

According to an embodiment, in operation S110, the altitude and the azimuth of the sun corresponding to the current date, current time, and location information of the vehicle may be obtained by using a sun path diagram.

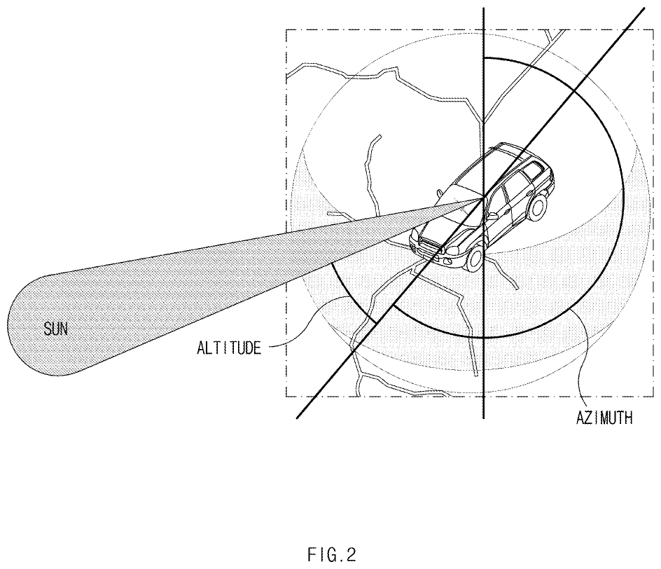

For example, as shown in FIG. 2, in operation S110, the current date, current time, latitude, and longitude information may be obtained through a GPS mounted on a vehicle, and the altitude and the azimuth may be calculated or obtained by using a sun path diagram together with the current date, current time, latitude, and longitude information.

With the altitude and the azimuth of the sun obtained in operation S110, in operation S120, a straight line or straight line equation between the sun and the camera in three-dimensional space can be generated based on the altitude and the azimuth of the sun.

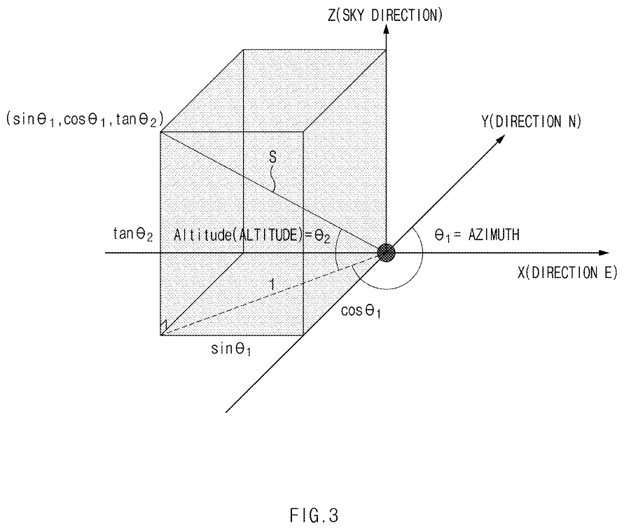

For example, as shown in FIG. 3, in operation S120, a straight line equation between a position vector S of the sun and the origin corresponding to the position of the camera may be derived. When the azimuth is θ₁ and the altitude is θ₂, the vector S is (sin θ₁, cos θ₁, tan θ₂), and a straight line equation “l” passing through the vector S and the origin may be expressed as following Equation 1.

$$l = \frac{x}{sin {θ}_{1}} = \frac{y}{cos {θ}_{1}} = \frac{z}{tan {θ}_{2}} \qquad [ Equation 1 ]$$

With the straight line or straight line equation between the position of the sun and the camera generated in operation S120, the lens surface of the camera in three-dimensional space can be generated based on the moving direction of the vehicle and the lens surface angle of the camera in operation S130.

According to an embodiment, in operation S130, three points on X, Y, and Z axes in three-dimensional space may be obtained based on the angle to the moving direction of the vehicle and the lens surface angle, and a surface created by the three points may be generated as the lens surface of the camera.

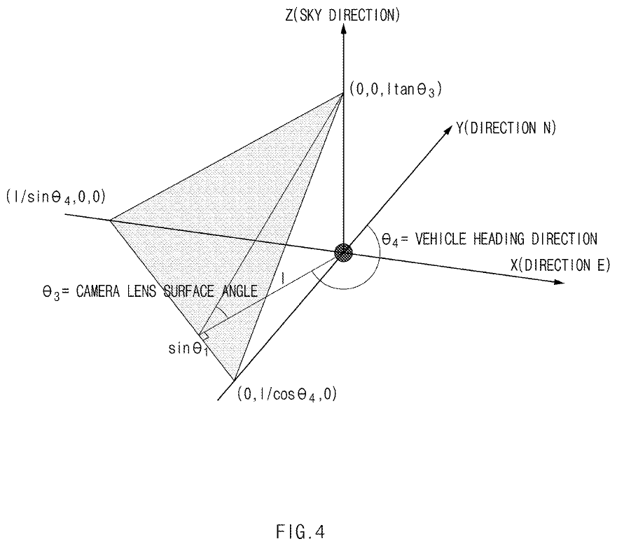

For example, in operation S130, as shown in FIG. 4, when the camera lens surface angle and the moving direction of the vehicle are θ₃ and θ₄, the three points on the X-axis, Y-axis, and Z-axis can be (l/sin θ₄, 0, 0), (0, l/cos θ₄, 0), and (0, 0, l tan θ₃), and the lens surface α₁ of the camera may be expressed or generated by following Equation 2.

$$\frac{x}{\frac{l}{sin} {θ}_{4}} + \frac{y}{\frac{l}{cos} {θ}_{4}} + \frac{z}{l tan {θ}_{3}} = 1 \qquad [ Equation 2 ]$$

$${α}_{1} : sin {θ}_{4} x + \frac{l}{cos {θ}_{4} y} + \frac{z}{tan {θ}_{3}} = l$$

Where l′ may mean the distance between the origin and the straight line obtained by connecting the X-axis point (l/sin θ₄, 0, 0) and the Y-axis point (0, l/cos θ₄, 0).

The camera lens surface angle may be a preset parameter, and the moving direction of the vehicle may be detected by a sensor capable of detecting the heading angle of the vehicle.

In operation S130, three points (l/sin θ₄, 0, 0), (0, l/cos θ₄, 0) and (0, 0, l tan θ₃) in three-dimensional space may be obtained by using the camera lens surface angle θ3 and the moving or heading direction of the vehicle θ₄, and the surface formed by the three points obtained may be generated as the lens surface of the camera.

With the lens surface of the camera is created in three-dimensional space in operation S130, it can be determined whether the straight line or the straight line equation generated in operation S120 passes through the lens surface of the camera, and when it is determined that the straight line passes through the lens surface of the camera, it can be determined that an error occurs in the image recognition of the camera in operation S140.

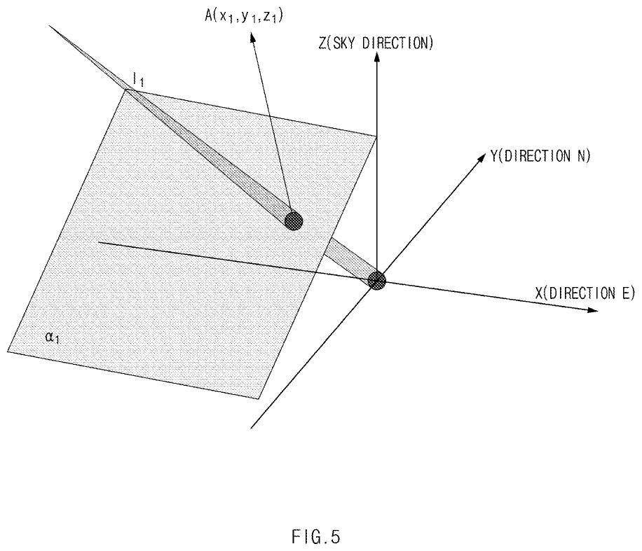

According to an embodiment, in operation S140, as shown in FIG. 5, it is possible to specify point A (x1, y1, z1) where the straight line 11 from which solar light is directed to the camera intersects the camera lens surface α₁, and when point A and the origin, at which the camera is located, coincide, it may be determined that the corresponding camera is in a VFS situation due to the sun or bright light, an error in the image recognition of the camera may occur. In operation S140, it can be possible for the VFS situation of the corresponding camera to be determined based on the point where the surface of the camera lens is mounted on the vehicle and the straight line from which sunlight goes to the camera origin meet.

According to an embodiment, in operation S140, it may be determined that an error occurs in the image recognition of the camera when it is determined that a straight line passes through the lens surface of the camera for a preset first time, for example, 1 second.

When it is determined that an error occurs in camera image recognition through the above-described process, it can be possible to output the determination result that an error occurs in camera image recognition at a time point when a preset second time, for example, 5 seconds, has elapsed.

The first time and the second time may be determined by a business operator or individual providing the technology of the present disclosure.

The method of FIG. 1 described above relates to a method of determining the VFS of a camera based on the position of the sun. The method according to an embodiment of the present disclosure can be characterized by an operation of determining camera VFS based on the position of the sun shown in FIG. 1. The method may determine/output the final result on the occurrence of a camera image recognition error by combining the result of determining whether an error occurs in camera image recognition through the sun position-based camera VFS determination process and the result of determining whether an error occurs in camera image recognition through the camera VFS determination process using an existing artificial intelligence learning model.

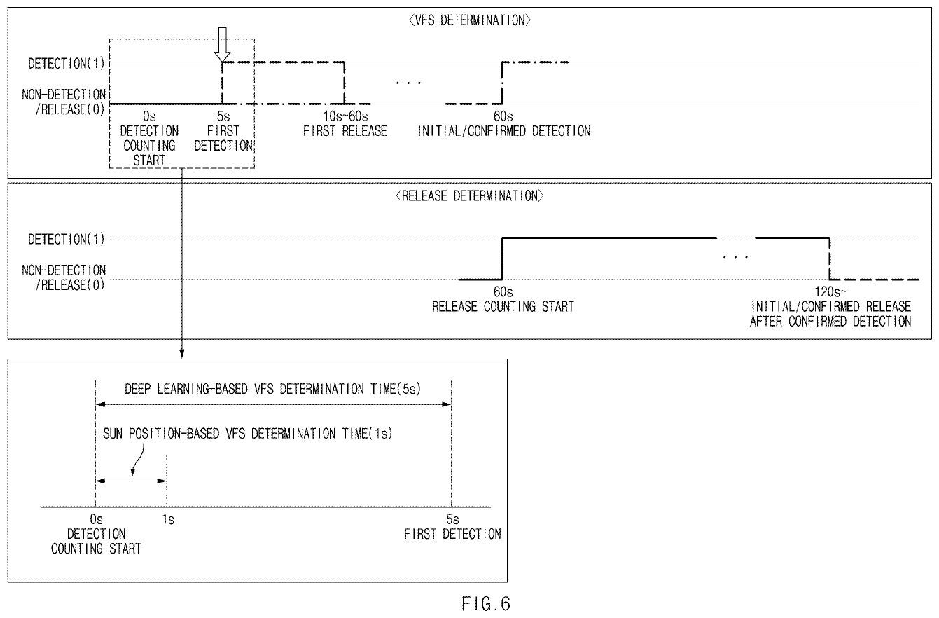

For example, as shown in FIG. 6, a method according to an embodiment of the present disclosure may determine the final result on the occurrence of a camera image recognition error by combining the sun position-based VFS determination and deep learning-based VFS determination. For example, the method may output the VFS determination result by considering the VFS determination reference at the first detection time point (e.g., 5 seconds) together with the sun position-based VFS determination reference.

By the VFS determination through a deep learning model based on pixel segmentation, an error in camera image recognition may be first detected when the VFS area lasts for 5 seconds or more, and the error detection in camera image recognition may be finally confirmed when the error detection in camera image recognition lasts for 60 seconds or more.

As described above, a method according to an embodiment of the present disclosure may combine a deep learning model with an integrated VFS determination based on VFS determination using the sun position, and provide the final VFS determination result based on the VFS determination results of the two conditions.

In a method according to an embodiment of the present disclosure, VFS misrecognition and non-recognition may occur, and the criteria for distinguishing misrecognition and non-recognition conditions may be as follows. For example, the method according to the embodiment of the present disclosure may set the case where it is determined to be a deep learning-based VFS situation even though it is not an actual sun position-based VFS situation as a reference for the misrecognition condition, and although it is an actual sun position-based VFS situation, when it is not determined as a deep learning-based VFS situation, may set it as a reference for non-recognition conditions.

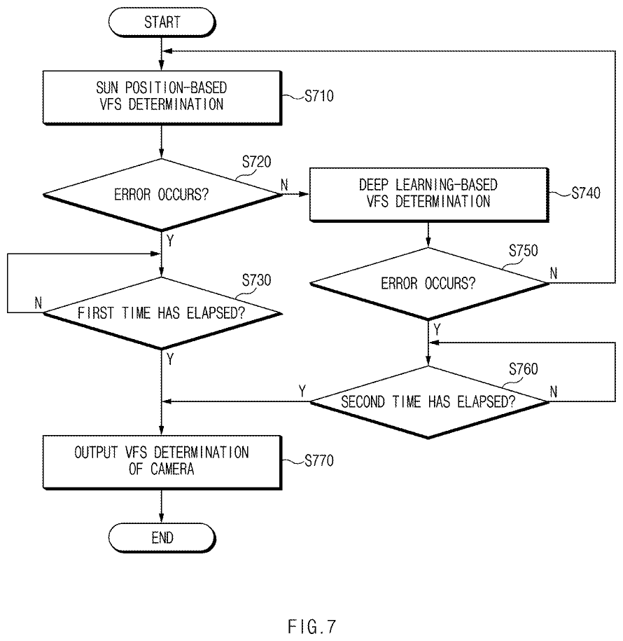

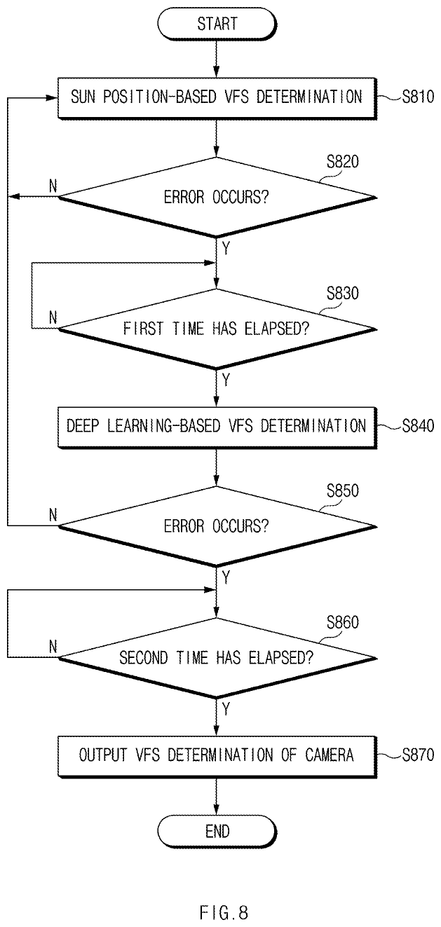

Furthermore, in the method according to an embodiment of the present disclosure, the operation of determining the VFS situation when entering a daytime tunnel or changing vehicle direction during daytime driving may be different from the operation of determining the VFS situation when driving on a general road during the day. This will be described with reference to FIGS. 7 and 8.

FIG. 7 is a flowchart illustrating an example of a VFS determination operation when entering a tunnel during the day or changing a vehicle direction. In FIG. 7, because a sudden difference in illuminance may cause a VFS determination delay or non-recognition, the initial VFS determination output may be provided at a certain time, for example, 5 seconds, by ORing the sun position-based VFS determination result and the deep learning-based VFS determination result.

Referring to FIG. 7, in operations S710, S720, S730, and S770, when entering a daytime tunnel or changing vehicle direction, when it is determined that an error occurs in camera image recognition by determining the VFS based on the sun position shown in FIG. 1, the VFS determination result of the camera may be output at a preset first time, for example, a time point when 1 second has elapsed, and although not shown, the VFS determination result of the camera at a time point when 1 second has elapsed may be finally output at a preset second time point, for example, when 5 second has elapsed after it is maintained for 5 seconds.

Then, in operations S740, S750, S760, and S770, when the VFS is determined based on the sun position and it is determined that any errors do not occur in camera image recognition, that is, when it is determined that it is not a VFS situation based on the sun position, the VFS situation can be determined based on deep learning. And when it is determined that an error has occurred in camera image recognition by determining the VFS based on deep learning, the VFS determination result of the camera can be output when the second time has elapsed.

In FIG. 7, even when it is determined that it is not a VFS situation within 1 second as a result of the VFS decision based on the sun position, when it is determined to be a deep learning-based VFS situation within 5 seconds, the initial VFS determination, that is, the determination result that an error occurs in camera image recognition, can be output.

FIG. 8 is a flowchart illustrating an example of a VFS determination operation when driving on a general road during the day. In FIG. 8, because misrecognition may occur as a result of deep learning-based VFS determination, an operation of providing the first VFS determination output by ANDing the sun position-based VFS determination result and the deep learning-based VFS determination result is shown.

Referring to FIG. 8, in operations S810 to S870, when driving on a general road during the day, when it is determined that an error occurs in camera image recognition by determining the VFS based on the sun position shown in FIG. 1, the VFS situation can be determined based on deep learning after a preset first time, for example, 1 second, has elapsed, and when it is determined that an error occurs in camera image recognition by determining the VFS based on deep learning, the VFS determination result of the camera can be output when the second time has elapsed.

In FIG. 8, when driving on a general road during the day, the VFS situation can be determined within 1 second as the VFS determination result based on the sun position, and only in the VFS situation as the deep learning-based VFS determination result within 5 seconds, the determination result can be output as the first VFS situation at a time point of 5 seconds, for example.

Although it is a VFS situation within 1 second as the VFS determination result based on the sun position, when it is not a VFS situation as the deep learning-based VFS determination result within 5 seconds, it may be determined that it is not the final VFS situation. In addition, although it is determined that it is not a VFS situation with 1 second as the VFS determination result based on the sun position, even when it is a VFS situation as a deep learning-based VFS determination result within 5 seconds, it may be determined that it is not a final VFS situation.

Furthermore, a method according to an embodiment of the present disclosure may output the final VFS determination result only with the deep learning-based VFS determination result when bright light is generated by front/rear vehicle headlights at night.

A method according to an embodiment of the present disclosure may distinguish between daytime and nighttime based on the vehicle driving time, but because a situation may occur where the difference in illumination is not large due to the influence of weather, and the like, time information, weather information, and surrounding environment, illuminance information, and the like, may be additionally utilized.

For example, a method according to an embodiment of the present disclosure may determine the sun position-based VFS situation of FIG. 1 by determining it as daytime driving when the illuminance sensor detects that the illuminance is above a reference illuminance or more for a certain period of time while driving on a daytime road. Furthermore, all available information may be utilized while a vehicle travels.

As described above, a method according to an embodiment of the present disclosure may determine whether the image recognition of the camera is fail-safe based on the position of the sun.

In addition, a method according to an embodiment of the present disclosure may determine the direction of the sun based on the current vehicle location, time, and direction information to use the direction of the sun as a reference value for determining image recognition fail-safe of each camera, so that it can be possible to improve the image non-recognition or misrecognition of each camera caused by the sun.

In addition, a method according to an embodiment of the present disclosure may improve the delayed determination of image recognition fail-safe that may occur due to sudden changes in illumination when entering a tunnel or changing a vehicle direction.

Furthermore, a method of determining the VFS state of a camera according to an embodiment of the present disclosure may determine the VFS state of the camera through the straight line between the sun and the camera, the shooting direction of the camera, and the moving direction of the vehicle. For example, a method according to an embodiment of the present disclosure may obtain location information of the sun based on a current date and current time, generate a straight line between the sun and a camera based on position information of the sun and location information of a vehicle, and determine whether an error occurs in image recognition of the camera based on the straight line, a capturing direction of the camera, and a moving direction of the vehicle. According to an embodiment, a method may determine the VFS situation for a camera when the shooting direction of the camera and the direction of the straight line match within a specified range according to the moving direction of the vehicle.

FIG. 9 is a block diagram illustrating an apparatus for determining fail-safe of camera image recognition according to an embodiment of the present disclosure, which performs the methods described with reference to FIGS. 1 to 8, for example.

Referring to FIG. 9, an apparatus 900 for determining fail-safe of camera image recognition according to an embodiment of the present disclosure includes an obtaining device 910, a generating device 920, a determining device 930, an outputting device 940, and storage 950.

The storage 950, which can be configured for storing various data related to the technology of the present disclosure, may store information about an image captured by a camera, camera parameter information, a sun path diagram, deep learning model based on pixel segmentation, information about an external parameter and internal parameter for each camera, the like, or any combination thereof. The storage 950 may store not only the information described above but any and all information related to the technology of the present disclosure.

The obtaining device 910 can obtain the altitude and the azimuth of the sun based on the current date, current time, and location information of the vehicle.

According to an embodiment, the obtaining device 910 may obtain the altitude and the azimuth of the sun corresponding to the current date, current time, and location information of the vehicle by using a sun path diagram.

For example, the obtaining device 910 may obtain the current date, current time, latitude, and longitude information through a GPS mounted on a vehicle, and obtain the altitude and the azimuth by using a sun path diagram together with the current date, current time, latitude, and longitude information.

The generating device 920 can generate a straight line or straight line equation between the sun and the camera in three-dimensional space based on the altitude and the azimuth of the sun, and generate the lens surface of the camera in three-dimensional space based on the moving direction of the vehicle and the lens surface angle of the camera.

According to an embodiment, the generating device 920 may generate three points on X, Y, and Z axes in three-dimensional space based on the angle to the moving direction of the vehicle and the lens surface angle, and generate a surface created by the three points as the lens surface of the camera.

The determining device 930 can determine whether the straight line or straight line equation generated from the generating device 920 passes through the lens surface of the camera, and determine that an error occurs in the image recognition of the camera when determining that the straight line passes through the lens surface of the camera. The determining device 930 may determine a camera VFS situation when it is determined that the straight line passes through the lens surface of the camera.

According to an embodiment, the determining device 930 may specify a point where the straight line from which solar light is directed to the camera meets the camera lens surface. When the point where the lens surface meets and the origin which is the position of the camera coincides, the determining device 930 may determine that the camera may be in a VFS situation due to the sun or bright light, that is, an error may occur in the image recognition of the camera.

According to an embodiment, when it is determined that the straight line passes through the lens surface of the camera for a preset first time, for example, 1 second, the determining device 930 may determine that an error occurs in the image recognition of the camera.

According to an embodiment, the determining device 930 may determine a final result for the occurrence of a camera image recognition error by combining the result of determining whether an error occurs in camera image recognition through the sun position-based camera VFS determination process and the result of determining whether an error occurs in camera image recognition through the camera VFS determination process using an existing artificial intelligence learning model.

For example, the determining device 930 may determine whether the error occurs in the image recognition of the camera by using an artificial intelligence learning model based on pixel segmentation using image information captured by the camera during a second time set to be longer than the first time as input when it is not determined that the error occurred in the image recognition of the camera based on the position of the sun during the first time.

As another example, the determining device 930 may determine that an error occurs in the image recognition of the camera when it is determined that the error occurred in the image recognition of the camera based on the position of the sun during the first time, and when it is determined that the error occurs in the image recognition of the camera by using an artificial intelligence learning model during a second time.

The outputting device 940 may output a result of determining that the error occurs in the image recognition of the camera at a time point when the second time elapses when it is determined that the error occurs in the image recognition of the camera based on the position of the sun or the artificial intelligence learning model.

Although the description is omitted in an apparatus according to another embodiment of the present disclosure, the apparatus according to another embodiment of the present disclosure may include all contents described in the methods of FIGS. 1 to 8, for example.

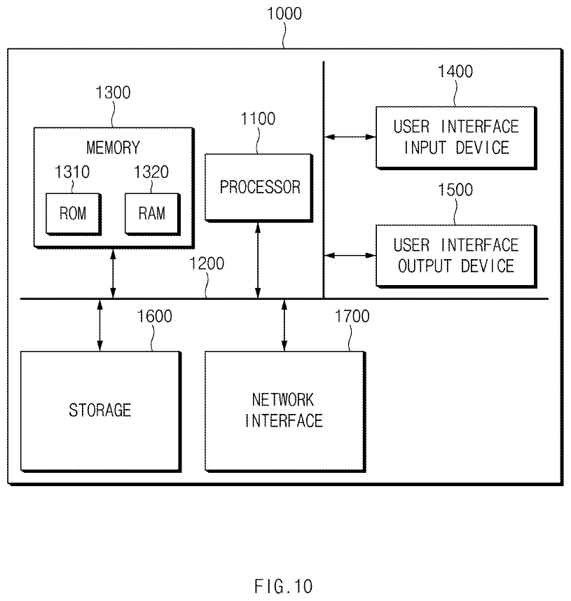

FIG. 10 is a block diagram illustrating a computing system for executing a method of determining fail-safe of camera image recognition according to an embodiment of the present disclosure.

Referring to FIG. 10, a method of determining fail-safe of camera image recognition according to an embodiment of the present disclosure described above may be implemented through a computing system 1000. The computing system 1000 may include at least one processor 1100, a memory 1300, a user interface input device 1400, a user interface output device 1500, storage 1600, and a network interface 1700 connected through a system bus 1200, any and all of which may be in plural.

The processor 1100 may be a central processing device (CPU) or a semiconductor device that processes instructions stored in the memory 1300 and/or the storage 1600, any and all of which may be in plural. The memory 1300 and the storage 1600 may include various types of volatile or non-volatile storage media. For example, the memory 1300 may include a ROM (Read Only Memory) 1310 and a RAM (Random Access Memory) 1320.

Accordingly, the processes of the method or algorithm described in relation to the embodiments of the present disclosure may be implemented directly by hardware executed by the processor 1100, a software module, or a combination thereof. The software module may reside in a storage medium (e.g., the memory 1300 and/or the storage 1600), such as a RAM, a flash memory, a ROM, an EPROM, an EEPROM, a register, a hard disk, solid state drive (SSD), a detachable disk, a CD-ROM, or any combination thereof, for example. The exemplary storage medium can be coupled to the processor 1100, and the processor 1100 may read information from the storage medium and may write information in the storage medium. In another method, the storage medium may be integrated with the processor 1100. The processor 1100 and the storage medium may reside in an application specific integrated circuit (ASIC). The ASIC may reside in a user terminal. In another method, the processor 1100 and the storage medium may reside in the user terminal as an individual component.

According to an embodiment of the present disclosure, by determining whether the camera is image recognition fail-safe based on the position of the sun, it can be possible to improve the delayed determination of image recognition fail-safe that may occur due to sudden changes in illuminance when entering a tunnel or changing vehicle direction.

According to an embodiments of the present disclosure, the direction of the sun may be determined through the current vehicle's location, time, and orientation information and used as a reference value for image recognition fail-safe determination for each camera, thereby improving image non-recognition or misrecognition of a camera due to the sun.

Effects obtained by various embodiments of the disclosure are not necessarily limited to the above, and other effects can be clearly understandable to those having ordinary skill in the art from the following disclosures.

Although example embodiments of the present disclosure have been described for illustrative purposes, those skilled in the art can appreciate that various modifications, additions and substitutions can be possible, without departing from the scope and spirit of the disclosure. Therefore, the example embodiments disclosed in the present disclosure are provided for the sake of descriptions, not necessarily limiting the technical concepts of the present disclosure, and it can be understood that such example embodiments are not intended to necessarily limit the scope of the technical concepts of the present disclosure. The protection scope of the present disclosure can be understood by the claims below, and all the technical concepts within the equivalent scopes can be interpreted to be within the scope of the right of the present disclosure.

What is claimed is:

1. A method of detecting soiling of camera image recognition, the method comprising:
obtaining an altitude and an azimuth of the sun based on a current date, a current time, and location information of a vehicle;
generating a straight line between the sun and a camera in a three-dimensional space based on the altitude and the azimuth of the sun;
generating a lens surface of the camera in the three-dimensional space based on a moving direction of the vehicle and a lens surface angle of the camera; and
determining that an error occurs in image recognition of the camera in response to the straight line passing through the lens surface.

2. The method of claim 1, wherein the obtaining of the altitude and the azimuth comprises obtaining the altitude and the azimuth of the sun corresponding to the current date, the current time, and the location information of the vehicle by using a sun path diagram.

3. The method of claim 1, wherein the generating of the lens surface of the camera comprises obtaining three points on X, Y, and Z axes in the three-dimensional space based on the moving direction of the vehicle and the lens surface angle, and generating a surface created by the three points as the lens surface of the camera.

4. The method of claim 1, wherein the determining of the error occurrence comprises determining that the error occurs in the image recognition of the camera based on a position of the sun during a first time preset.

5. The method of claim 4, wherein the determining of the error occurrence comprises determining whether the error occurs in the image recognition of the camera by using an artificial intelligence learning model based on pixel segmentation using image information captured by the camera during a second time set to be longer than the first time as input if it is not determined that the error occurred in the image recognition of the camera based on the position of the sun during the first time.

6. The method of claim 5, further comprising outputting a result of determining that the error occurs in the image recognition of the camera at a time point after the second time elapses if it is determined that the error occurs in the image recognition of the camera based on the position of the sun or the artificial intelligence learning model.

7. The method of claim 4, wherein the determining of the error occurrence comprises determining that the error occurs in the image recognition of the camera if it is determined that the error occurs in the image recognition of the camera based on the position of the sun during the first time, and if it is determined that the error occurs in the image recognition of the camera by using an artificial intelligence learning model based on pixel segmentation using image information captured by the camera during a second time set to be longer than the first time as input.

8. A method of detecting soiling of camera image recognition, the method comprising:
obtaining location information of the sun based on a current date and a current time;
generating a straight line between the sun and a camera based on position information of the sun and location information of a vehicle; and
determining whether an error occurs in image recognition of the camera based on the straight line, a capturing direction of the camera, and a moving direction of the vehicle.

9. An apparatus for detecting soiling of camera image recognition, the apparatus comprising:
a processor; and
a memory;
wherein the processor is configured to:
obtain an altitude and an azimuth of the sun based on a current date, a current time, and location information of a vehicle;
generate a straight line between the sun and a camera in a three-dimensional space based on the altitude and the azimuth of the sun, and generate a lens surface of the camera in the three-dimensional space based on a moving direction of the vehicle and a lens surface angle of the camera; and
determine that an error occurs in image recognition of the camera if the straight line passes through the lens surface.

10. The apparatus of claim 9, wherein the processor is configured to obtain the altitude and the azimuth of the sun corresponding to the current date, the current time, and the location information of the vehicle by using a sun path diagram.

11. The apparatus of claim 9, wherein the processor is configured to obtain three points on X, Y, and Z axes in the three-dimensional space based on the moving direction of the vehicle and the lens surface angle, and generate a surface created by the three points as the lens surface of the camera.

12. The apparatus of claim 9, wherein the processor is configured to determine that the error occurs in the image recognition of the camera based on the position of the sun during a first time preset.

13. The apparatus of claim 12, wherein the processor is configured to determine whether the error occurs in the image recognition of the camera by using an artificial intelligence learning model based on pixel segmentation using image information captured by the camera during a second time set to be longer than the first time as input if it is not determined that the error occurred in the image recognition of the camera based on the position of the sun during the first time.

14. The apparatus of claim 13, wherein the processor is configured to output a result of determining that the error occurs in the image recognition of the camera at a time point after the second time elapses if it is determined that the error occurs in the image recognition of the camera based on the position of the sun or the artificial intelligence learning model.

15. The apparatus of claim 12, wherein the processor is configured to determine that the error occurs in the image recognition of the camera if it is determined that the error occurred in the image recognition of the camera based on the position of the sun during the first time, and if it is determined that the error occurs in the image recognition of the camera by using an artificial intelligence learning model based on pixel segmentation using image information captured by the camera during a second time set to be longer than the first time as input.
